(19) United States
(12) Patent Application Publication
(10) Pub. No.: US 2025/0045709 A1
(43) Pub. Date: Feb. 6, 2025

(54) SYSTEMS AND METHODS FOR ADVANCED VEHICLE REPAIR SYSTEMS

(71) Applicant: State Farm Mutual Automobile Insurance Company, Bloomington, IL (US)

(72) Inventors: Julie L. Blankenship, Chandler, AZ (US); Patrick T. Carron, Oakwood, OH (US); Dillon M. Carty, Cumming, GA (US); Dustin L. Barrons, Columbia, MO (US); Andrew K. Pulkstenis, Mahomet, IL (US); Jeremy M. Mulcahey, Chamblee, GA (US)

(21) Appl. No.: 18/792,506

(22) Filed: Aug. 1, 2024

Related U.S. Application Data
(60) Provisional application No. 63/517,278, filed on Aug. 2, 2023.

(51) Int. Cl. G06Q 10/20; G07C 5/08

(52) U.S. Cl. CPC G06Q 10/20; G07C 5/0808

(57) ABSTRACT

A computer system for real-time monitoring of a workload for a plurality of repair facilities is provided. The computer system comprises a processor and a memory. The processor is programmed to collect a plurality of current service data for a plurality of machine-learning models trained to determine workloads for the plurality of vehicle repair facilities based upon a plurality of historical service data for the plurality of repair facilities, execute the plurality of machine-learning models to generate a workload ranking for the plurality of repair facilities, receive a query requesting service for repairing a user vehicle, execute the query to determine the one or more repair facilities having availability based upon the plurality of workload rankings of the plurality of repair facilities to provide the service for repairing the user vehicle, and cause the user computer device to display a the one or more determined repair facilities.

### CROSS-REFERENCE TO RELATED APPLICATIONS

This application claims priority to U.S. Provisional Patent Application No. 63/517,278, filed Aug. 2, 2023, the entire contents and disclosure of which are hereby incorporated herein by reference in their entirety.

### FIELD OF THE DISCLOSURE

The present disclosure relates to repairing damage to a vehicle and, more particularly, to a network-based system and method for real-time monitoring of repairs being performed at a plurality of repair facilities and reporting to a user the various real-time facility loads for improved vehicle repair.

### BACKGROUND

Current repair facility locator systems can drive too much repair work volume to one or two repair facilities in a particular area, while leaving excess capacity unused at other repair facilities in the market. This misallocation of work can lead to increases in cycle time, rental duration, and decreased customer satisfaction. While quality and speed of work is important, availability is an additional element needed when identifying facilities for performing vehicle repair work. Existing systems have limited insight into real-time repair facility capacity and current repair facility work in progress (WIP). Driving too much volume to the highest performers in a program can cause those high performers to become overwhelmed. Furthermore, some programs expect priority given to specific customers, where it is difficult to measure whether this is being done. Accordingly, it would be desirable to have a system for knowing the real-time capacity of repair facilities so as to better manage workload between these facilities.

### BRIEF SUMMARY

The present embodiments may relate to systems and methods for real-time monitoring of a workload at a plurality of vehicle repair facilities. The system may include a repair monitoring (RM) computer system, one or more insurer network computer devices, one or more user devices, and/or one or more repair facility computer devices. The RM computer system may be associated with an insurance network or may be merely in communication with an insurance network.

The RM computer system may be configured to: a) store a plurality of machine-learning (ML) models trained to determine workloads for the plurality of repair facilities based upon a plurality of historical vehicle repair information for the plurality of repair facilities; b) collect a plurality of current service data for inputting into and updating the plurality of ML models; c) update the plurality of ML models with the plurality of current service data; d) execute the plurality of machine-learning models with the plurality of current service data to generate a plurality of workload rankings for the plurality of repair facilities; e) receive, from a user computer device, a query requesting availability for one or more of the repair facilities to provide a service to a user; f) execute the query to determine the one or more repair facilities to respond to the user's service request based upon the plurality of workload rankings of the plurality of repair facilities; g) generate and transmit, to the user computer device, a plurality of instructions to cause the user computer device to display the one or more determined repair facilities; h) receive the plurality of current service data from a plurality of computer devices associated with the plurality of repair facilities; i) wherein the plurality of current service data includes a current load for each of the plurality of repair facilities; j) remove a repair facility from the one or more determined repair facilities based upon a workload ranking of the repair facility; k) remove a repair facility from the one or more determined repair facilities based upon a current capacity of the repair facility; l) receive a plurality of performance data from the plurality of repair facilities; m) retrain the plurality of machine-learning models based upon the plurality of performance data; n) collect a plurality of updated current service data for the plurality of machine-learning models; o) update the plurality of machine-learning models with the plurality of updated current service data; p) execute the plurality of machine-learning models with the plurality of updated current service data to generate an updated plurality of workload rankings for the plurality of repair facilities; q) determine a condition of a vehicle to be repaired; r) re-rank the plurality of repair facilities based upon the condition of the vehicle to be repaired; s) analyze the plurality of vehicle repair information, wherein the plurality of current service data includes a plurality of vehicle repair information; t) execute one or more machine-learning models with the plurality of vehicle repair information as inputs to determine a current load for the corresponding repair facility; u) adjust the plurality of workload rankings for the plurality of repair facilities based upon the plurality of current loads; v) reduce a workload ranking for a repair facility when the one or more machine-learning models determines that the repair facility is over capacity; w) determine that a repair facility is over capacity when an average time to completion is greater than or equal to 45 days; x) generate a user interface to provide vehicle repair information based on a user selected geographic area; y) wherein each model of the plurality of machine-learning models represents a different geographic regions; z) wherein each model includes a plurality of repair facilities in the corresponding geographic region; and/or aa) rank the plurality of repair facilities in the corresponding geographic regions. The RM computer system may have additional, less, or alternate functionality, including that discussed elsewhere herein.

In one aspect, a computer system for monitoring a plurality of repair facilities may be provided. The computer system may include at least one processor (and/or associated transceiver) in communication with at least one memory device. The computer system is in communication with a user computer device associated with a user. The at least one processor (and/or associated transceiver) may be configured or programmed to: i) store a plurality of machine-learning (ML) models trained to determine workloads for the plurality of repair facilities based upon a plurality of historical vehicle repair information for the plurality of repair facilities; ii) collect a plurality of current service data for inputting into and updating the plurality of ML models; iii) update the plurality of ML models with the plurality of current service data; iv) execute the plurality of machine-learning models with the plurality of current service data to generate a plurality of workload rankings for the plurality of repair facilities; v) receive, from a user computer device, a query requesting availability for one or more of the repair facilities to provide a service to a user; vi) execute the query to determine the one or more repair facilities to respond to the user's service request based upon the plurality of workload rankings of the plurality of repair facilities; and/or vii) generate and transmit, to the user computer device, a plurality of instructions to cause the user computer device to display the one or more determined repair facilities. The computer system may have additional, less, or alternate functionality, including that discussed elsewhere herein.

In another aspect, a computer-implemented method for monitoring a plurality of repair facilities may be provided. The method may be implemented on a repair monitoring (“RM”) computer system including at least one processor in communication with at least one memory device. The RM computer system is further in communication with a user computer device associated with a user. The method may include: i) storing a plurality of machine-learning (ML) models trained to determine workloads for the plurality of repair facilities based upon a plurality of historical vehicle repair information for the plurality of repair facilities; ii) collecting a plurality of current service data for inputting into and updating the plurality of ML models; iii) updating the plurality of ML models with the plurality of current service data; iv) executing the plurality of machine-learning models with the plurality of current service data to generate a plurality of workload rankings for the plurality of repair facilities; v) receiving, from a user computer device, a query requesting availability for one or more of the repair facilities to provide a service to a user; vi) executing the query to determine the one or more repair facilities to respond to the user's service request based upon the plurality of workload rankings of the plurality of repair facilities; and/or vii) generating and transmitting, to the user computer device, a plurality of instructions to cause the user computer device to display the one or more determined repair facilities. The method may have additional, less, or alternate functionality, including that discussed elsewhere herein.

In at least one further aspect, at least one non-transitory computer-readable storage media having computer-executable instructions embodied thereon may be provided. When executed by at least one processor, the computer-executable instructions may cause the processor to: i) store a plurality of machine-learning (ML) models trained to determine workloads for the plurality of repair facilities based upon a plurality of historical vehicle repair information for the plurality of repair facilities; ii) collect a plurality of current service data for inputting into and updating the plurality of ML models; iii) update the plurality of ML models with the plurality of current service data; iv) execute the plurality of machine-learning models with the plurality of current service data to generate a plurality of workload rankings for the plurality of repair facilities; v) receive, from a user computer device, a query requesting availability for one or more of the repair facilities to provide a service to a user; vi) execute the query to determine the one or more repair facilities to respond to the user's service request based upon the plurality of workload rankings of the plurality of repair facilities; and/or vii) generate and transmit, to the user computer device, a plurality of instructions to cause the user computer device to display the one or more determined repair facilities. The computer-executable instructions may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary computer-implemented process for one aspect of the process of monitoring the capacity of repair facilities, in accordance with the present disclosure.

FIG. 2 illustrates a timing diagram for one aspect of the process of monitoring the capacity of repair facilities, in accordance with the present disclosure.

FIG. 3 illustrates a simplified block diagram of an exemplary computer system for implementing the processes shown in FIGS. 1 and 2.

FIG. 4 illustrates an exemplary configuration of a user computer device, in accordance with one embodiment of the present disclosure.

FIG. 5 illustrates an exemplary configuration of a server computer device, in accordance with one embodiment of the present disclosure.

FIG. 6 illustrates a diagram of components of one or more exemplary computing devices that may be used in the system shown in FIG. 3.

FIG. 7 illustrates a flow chart of another exemplary computer-implemented process for one aspect of the process of monitoring the capacity of repair facilities, in accordance with the present disclosure.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION OF THE DRAWINGS

The present embodiments may relate to, inter alia, systems and methods for monitoring repairs being performed at a plurality of repair facilities and instructing reporting to a user the various repair facility loads for improved vehicle repair. In one exemplary embodiment, the process may be performed by a repair monitoring (“RM”) computer device. In the exemplary embodiment, the RM computer device may be in communication with a plurality of user computer devices, such as a mobile computer device, insurer network computer devices, and repair facility computer devices. In the exemplary embodiment, the RM computer device is in communication with a user computer device, where the RM computer device transmits data, such as a user interface, to the user computer device to be displayed to the user and receives the user's inputs from the user computer device.

In the exemplary embodiment, the RM computer device may train and execute one or more machine-learning models to predict the workloads at different repair facilities to balance workloads in real-time. The RM computer device may execute the one or more machine-learning models to identify and monitor the repair facility options to meet the customer's needs when considering a select service repair facility availability. More specifically, the one or more machine-learning models may predict when select service repair facilities are available for assignments or may have reached repair facilities capacity with current assignments.

In the exemplary embodiment, the RM computer device receives information from the plurality of computer devices associated with the plurality of different repair facilities. The RM computer device then feeds that information into the one or more machine-learning models as inputs. The RM computer device then executes the one or more machine-learning models to receive which of the plurality of repair facilities are at capacity. In at least one embodiment, the one or more machine-learning models determine the average number of days to completion for each of the plurality of repair facilities and the RM computer device compares that statistic to one or more thresholds. If the repair facility is over the one or more thresholds, then the RM computer device may rank that repair facility lower than other repair facilities when presenting options to a user looking for a repair facility. In other embodiments, the RM computer device may compare other statistics in place of and/or in addition to the average number of days to completion. In some further embodiments, the one or more machine-learning models outputs a field that indicates whether or not the repair facility is overloaded.

In at least one embodiment, the RM computer device applies data about the repair facility over a period of time as inputs to the one or more machine-learning models. For example, the RM computer device may apply five days of data from the repair facility to the one or more machine-learning models.

In the exemplary embodiment, the RM computer device is configured to train a plurality of machine-learning models with a plurality of historical information from the plurality of repair facilities. The RM computer device then tests the plurality of machine-learning models to determine which inputs affect the output of the prediction of which repair facility to use and how busy the corresponding repair facility is. Based on the results of the tests, the RM computer device determines which inputs have the most correlations with determining the current capacity of the corresponding repair facility. In some embodiments, the RM computer device may retrain and/or rebuild the one or more machine-learning models with the inputs that have the most correlation. Furthermore, the RM computer device may use the results to reduce the number of variables collected from the repair facility computer devices.

In some embodiments, the RM computer device trains different machine-learning models for different locations, such as core-based statistical areas (CBSA). For example, CBSA is core-based statistical area. The government organizes basically metropolitan areas and then analyzes the CBSAs that arise. For example, Minneapolis CBSA, or Columbia, Missouri CBSA. The government primarily does this for metro areas. Many companies stick to those areas and create a market based on the CBSA. In some of these embodiments, different geographic regions have different behavior patterns when it comes to shop capacity, work order acceptance, and/or workflow. Accordingly, the RM computer device trains the different machine-learning models for the different geographic regions. Then when an inquiry comes in from a user requesting a shop recommendation, the RM computer device selects the appropriate model for the appropriate geographic region and/or CBSA.

In some embodiments, the RM computer device trains the machine-learning models with a plurality of variables that may be provided by an insurance network computer device and/or one or more user computer device. These variables may include variables about the repair facility in question, the vehicle in question, any damage done to that vehicle, market attributes, insurance attributes, and/or any other attribute or variable desired.

In some embodiments, the repair facility variables may include, but are not limited to, repairer ID, total shop capacity, current shop capacity, market ID, repairer name, days to completion, Street, City, State, Zip Code, County, scores for the Repair Facility, ratings for the Repair Facility, one or more customer satisfaction indexes, and/or any other attribute or variable desired. The variables may also include RFL, which is a repair facility locator index, which is the placement in which the repair facilities based on a facility listing. The RFL is where the repair facility ranks in a market area as far as their performance goes. A further variable may be an RPM score, which is a Repair Performance Management score. It's a score between 0-1000. Repair facilities rank against each other in each market and the RFL is basically a copy of that number to help ranking in the repair facility locator.

The vehicle variables may include, but are not limited to, make, model, year, engine type, and/or any other attribute or variable desired. The damage done to the vehicle variables may consist of different codes to represent damage in different locations and/or the severity of the damage done to those locations. In some further embodiments, the damage done to the vehicle variables may also include an average amount of time to repair the corresponding damage to the vehicle, whether or not the vehicle is drivable, information about parts expected to be needed to repair the damage to the vehicle, and/or any other damage attributes or variables as needed. The market variables may include, but are not limited to, market ID, market name, current weather conditions, previous weather conditions, weather forecasts, previous average time to completion, number of repair facilities in the corresponding market, and/or any other attribute or variable desired.

In some embodiments, the one or more insurance variables may include, but are not limited to, policy coverage, preferred repair shops, rental vehicle coverage, ride share coverage, tow coverage, and/or any other attribute or variable as desired. In some embodiments, the one or more insurance variables are provided by an insurance network computer device. The one or more insurance variables from the insurance network computer device may be related to the vehicle and/or the incident in which the vehicle sustained the damage that is to be repaired, such as the vehicle variables and/or the damage variables.

In the exemplary embodiment, different markets affect the amount of repair facilities available. In some embodiments, different machine-learning models may be built for different markets aka locations to account for the variances in different parts of the country and to improve the training of the corresponding machine-learning models. For example, data from Kansas City may affect the model differently than data from Chicago. Accordingly, having machine-learning models tailored for the corresponding markets can allow for improved accuracy of prediction in those markets.

In some embodiments, the RM computer device and the one or more machine-learning models may be deployed in a plurality of situations. Starting with a candidate model, the RM computer device needs to be configured to be use it. The RM computer device may use the output for each repair facility as a way to rank the repair facilities and provide that information to an application, such as a repair facility locator. The RM computer device may start with an initial workload ranking which would be based on performance in the past and then adjusted by the output score from the one or more models to either raise or lower the identified repair facilities.

In at least one embodiment, the model clusters the plurality of variables. In some embodiments, the clusters are based on the correlation of each variable to the output.

In at least one embodiment, the output of the model is built to be run in a batch fashion daily. The RM computer device collects information from the last 5 days from everything that's been sent to the repair facility along with the other variables. In some embodiments, the number of variables needed have been reduced to remove variables that don't affect the predictions of the model. The model generates the prediction, which is essentially going to be a probability of whether or not this given repair facility, on a day, is going to be at or over capacity. In some embodiments, this can be determined based on whether or not the repair facility will take more than 45 days to get through their work. The model is configured to be at that level. Not the individual accident level, but at the repair facility and day level. The prediction would then affect the workload ranking of the repair facilities in a repair facility locator application that a user may access to determine which repair facility to use for their vehicle. For example, the prediction could affect the workload ranking of the way repair facilities are showing up when the user puts in a zip code. Then the RM computer device determines the repair facility that would be the top here in terms of RPM score. Then the RM computer device determines that it's going to take more than 45 days for that to get through the work, so then the RM computer device demotes that repair facility to the bottom of the list on this page instead of being the top. Accordingly, the RM computer device instructs the application to direct the user to repair facilities that are not at capacity. In some embodiments, the RM computer device may instruct a user to travel to a different area if all of the repair facilities are at capacity and the vehicle is drivable.

While the above describes a five-day rolling average for the input variables, in some embodiments, the RM computer device and/or the one or more machine-learning models may use more or less days of information for up-to-date analysis. Furthermore, the model is able to be trained for a cluster of repair facilities and then be executed for individual repair facilities, such as those in the cluster.

In at least one embodiment, the repair facilities are ranked on a periodic basis. Then the workload rankings are adjusted by the model on a daily basis taking into account all of the changes (e.g., work orders) that will affect the repair facilities ability to repair vehicles. This up-to-date information improves the loading at the repair facilities and directs the users to the best repair facility at the time due to current workloads.

In some embodiments, the one or more machine-learning models output a probability that the repair facility is at or over capacity. The RM computer device uses that probability to determine whether or not to indicate that repair facility is over capacity and lower its current workload ranking when presented to users. In at least one embodiment, the RM computer device may compare the probability to a threshold that may be set by the user and/or the operator of the RM computer device. In some embodiments, the threshold may change based on the market and/or other factors. In some further embodiments, an over capacity repair facility is removed from the listings instead of lowered in the workload rankings. In still further embodiments, when a user selects an over capacity repair facility, the RM computer device may present a notification to the user indicating that the repair facility may be over capacity. A user may then override that notification, such as when they live close to the repair facility and/or don't need the vehicle for a while.

While the above describe the object to be repaired as being a vehicle, the object may be one of any other object that needs to be analyzed to determine the amount of damage that the object has sustained. In some further embodiments, the object may be, but is not limited to, a personal possession, such as an antique clock, a piece of artwork, and/or a piece of furniture.

### Exemplary Computer-Implemented Method for Monitoring the Capacity of Repair Facilities

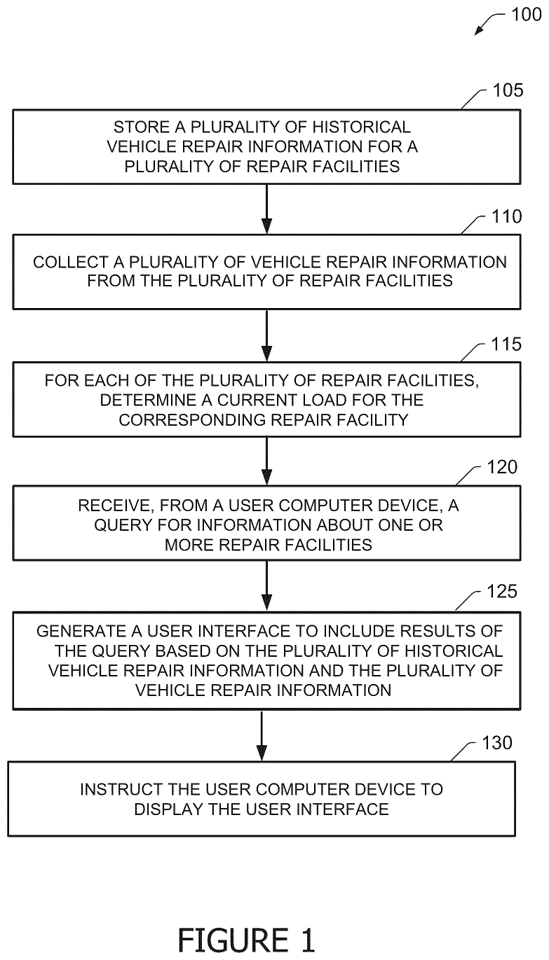

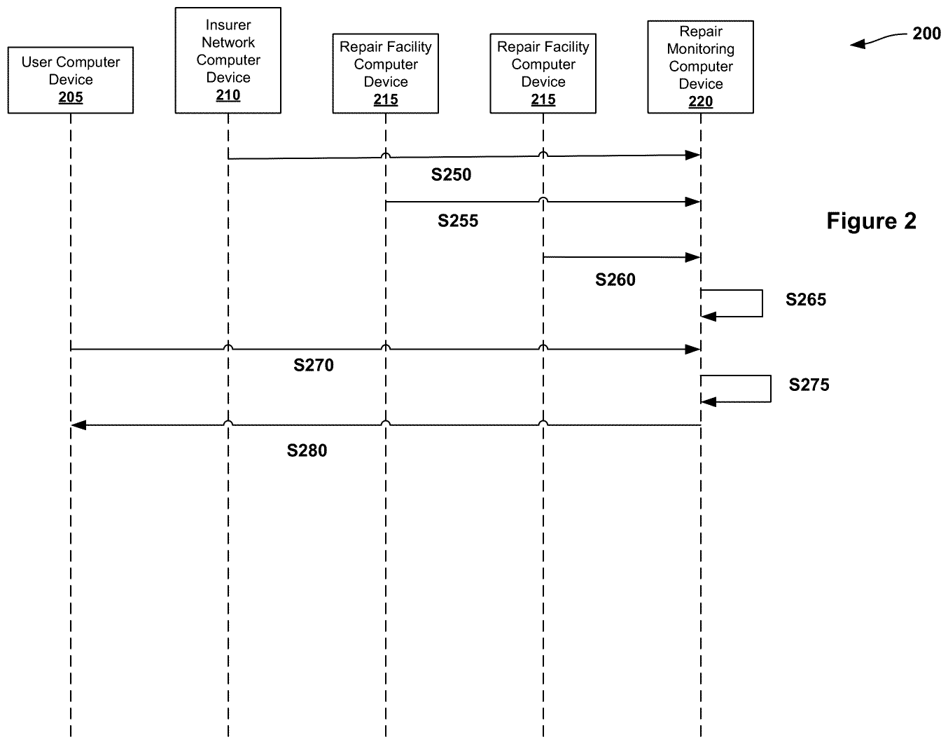

FIG. 1 illustrates a flow chart of an exemplary computer-implemented process 100 for one aspect of the process of monitoring the capacity of repair facilities, in accordance with the present disclosure. In the exemplary embodiment, process 100 is performed by a computer device associated with an insurance provider, such as repair monitoring (RM) computer device 220 (shown in FIG. 2). In other embodiments, process 100 is performed by a computer device in communication with an insurance provider. In the exemplary embodiment, RM computer device 220 is in communication with a user computer device, such as a mobile computer device, for example user computer device 205 (shown in FIG. 2). In this embodiment, RM computer device 220 performs process 100 by transmitting data to the user computer device 205 to be displayed to the user and receives the user's inputs from user computer device 205.

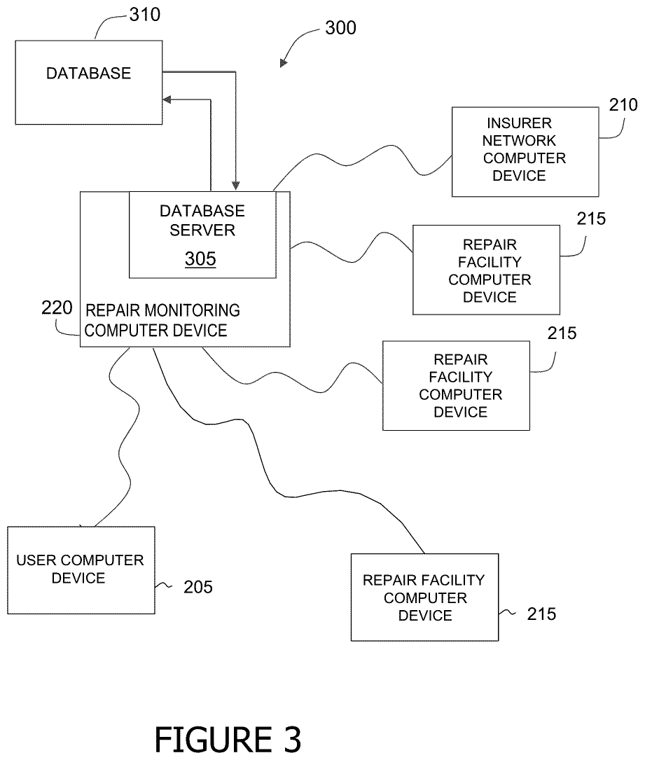

In the exemplary embodiment, the RM computer device 220 stores 105 a plurality of historical vehicle repair information for a plurality of repair facilities. In at least some embodiments, the plurality of historical vehicle repair information is stored in a database, such as database 310 (shown in FIG. 3).

In the exemplary embodiment, the RM computer device 220 collects 110 a plurality of vehicle repair information from the plurality of repair facilities. In some embodiments, the RM computer device 220 is in communication with a plurality of repair facility computer devices 215 (shown in FIG. 2), where each repair facility computer device 215 is associated with at repair facility of the plurality of repair facilities. In other embodiments, the plurality of repair facility computer devices 215 are in communication with the database 310 itself. In still other embodiments, the plurality of repair facility computer devices 215 are in communication with an insurer network computer device 210 and the insurer network computer device 210 receives the vehicle repair information and forwards the vehicle repair information to the database 310 and/or the RM computer device 220. In the exemplary embodiment, the RM computer device 220 stores the plurality of vehicle repair information from the plurality of repair facilities.

For each of the plurality of repair facilities, the RM computer device 220 analyzes 115 a current load for the corresponding repair facility based on the plurality of data in the database(s) 310 and the information collected 110 from the plurality of repair facilities. In the exemplary embodiment, the RM computer device 220 includes one or more machine-learning models for analyzing 115 the current load of each of the plurality of repair facilities. In at least one embodiment, the one or machine-learning models determines if the corresponding repair facility is overloaded. In some embodiments, the one or more machine-learning models determines that a repair facility is overloaded based upon the average number of days to repair exceeding a threshold, such as 45 days.

In the exemplary embodiment, the RM computer device 220 receives 120, from a user computer device 205, a query for information about one or more repair facilities. In the exemplary embodiment, the RM computer device 220 generates 125 a user interface to include results of the query based on the plurality of historical vehicle repair information and the plurality of vehicle repair information. In the exemplary embodiment, the RM computer device 220 generates 125 the user interface and ranks the repair facilities for the user to select. In the exemplary embodiment, the RM computer device 220 adjusts the workload rankings based on whether or not the corresponding repair facility is over capacity or not. In the exemplary embodiment, the RM computer device 220 instructs 130 the user computer device 205 to display the user interface.

In some embodiments, the RM computer device 220 ranks the plurality of repair facilities on a monthly basis. The RM computer device 220 also receives current service data from the plurality of repair facilities on a daily basis. The RM computer device 220 uses the current service data for a plurality of days (i.e., five) with one or more machine-learning models to determine the current capacity of the corresponding repair facility and then determines if the repair facility is at or over capacity. If the repair facility is over capacity, the RM computer device 220 may adjust the workload rankings. In some embodiments, if the repair facility is over capacity, the repair facility is not shown on the display. This display may be on a user computer device 205 and/or an insurer network computer device 210.

In some embodiments, the RM computer device 220 sorts the plurality of vehicle repair information by geographic area. The RM computer device 220 generates the user interface to provide vehicle repair information based on a user selected geographic area. For example, the geographic area may include, but is not limited to, enterprise, country, state, province, region, county, city, market, and/or individual repair facility.

In some further embodiments, the RM computer device 220 determines that a selected repair facility is over capacity. The RM computer device 220 instructs the user computer device 205 to present a notification warning that the repair facility may be over capacity.

In at least some embodiments, the RM computer device 220 determines a current capacity of the plurality of repair facilities based on the plurality of vehicle repair information. In some further embodiments, the RM computer device 220 receives a current or future weather condition. Then the RM computer device 220 determines a needed capacity based on the current or future weather condition, the plurality of vehicle repair information, and the plurality of historical vehicle repair information.

While the above describe repairing vehicles, the object to be repaired may be, but is not limited to, a personal possession, such as an antique clock, a piece of artwork, and/or a piece of furniture.

### Exemplary Process for Monitoring the Capacity of Repair Facilities

FIG. 2 illustrates a timing diagram for one aspect of the process 200 of monitoring the capacity of repair facilities, in accordance with the present disclosure.

Process 200 illustrates the communications between multiple computer devices. More specifically, a user computer device 205, an insurer network computer device 210, a repair facility computer devices 215, and a repair monitoring (“RM”) computer device 220. In the exemplary embodiment, RM computer device 220 may be in communication with one or more user computer devices 205, such as a mobile computer device, one or more insurer network computer devices 210, and a plurality of repair facility computer devices 215. In some embodiments, RM computer device 220 is in communication with another RM computer device 220. In some of these embodiments, each RM computer device 220 is assigned to monitor the repair facilities in a specific geographic area.

In step S250, the insurer network computer device 210 transmits information to the RM computer device 220. The information can include, but is not limited to, claims information, assignment information, information about relationships with different repair facilities, and other information as described herein. In steps S255 and 260, vehicle repair information is provided from the repair facility computer devices 215 to the RM computer device 220. The vehicle repair information includes information about current capabilities of the repair facility and those vehicles that are currently at or have received estimates from the repair facility.

In step S265, the RM computer device 220 stores and analyzes the data. The RM computer device 220 performs calculations to determine the capacity available and whether or not each repair facility is at capacity.

In the exemplary embodiment, steps S250 through S265 are being performed on a constant basis, such that repair facility computer devices 215 are providing up-to-date information to the RM computer device 220 and the RM computer device 220 is updating its analysis based on the currently provided information. In some embodiments, steps S255 through S265 are performed on a periodic basis, such as daily.

In step S270, a user computer device 205 requests information from the RM computer device 220. In response, in step S275, the RM computer device 220 generates an updated user interface based on the request. In step S280, the RM computer device 220 provides the updated user interface to the user computer device 205. In the exemplary embodiment, the user computer device 205 may refine its request to include updated/filtered/sorted/drilled down information. The RM computer device 220 then further updates the user interface it provides to the user computer device 205.

### Exemplary Computer Network

FIG. 3 depicts a simplified block diagram of an exemplary computer system 300 for implementing process 100 (shown in FIG. 1) and process 200 (shown in FIG. 2). In the exemplary embodiment, computer system 300 may be used for monitoring vehicle repairs across multiple repair facilities. As described below in more detail, a repair monitoring (“RM”) computer device 220 may be configured to (i) store a plurality of machine-learning models trained to determine loads for the plurality of repair facilities based upon a plurality of historical vehicle repair information for the plurality of repair facilities; ii) collect a plurality of current service data for the plurality of machine-learning models; iii) update the plurality of machine-learning models with the plurality of current service data; iv) execute the plurality of machine-learning models with the plurality of current service data to generate a plurality of workload rankings for the plurality of repair facilities; v) receive, from a user computer device 205, a query for one or more repair facilities; vi) execute the query to determine the one or more repair facilities to respond based upon the plurality of workload rankings of the plurality of repair facilities; and/or vii) generate and transmit, to the user computer device 205, a plurality of instructions to cause the user computer device 205 to display the one or more determined repair facilities.

In the exemplary embodiment, user computer devices 205 are computers that include a web browser or a software application, which enables user computer devices 205 to access remote computer devices, such as RM computer device 220 and insurer network computer devices 210, using the Internet or other network. More specifically, user computer devices 205 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 205 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 305 may be communicatively coupled to a database 310 that stores data. In one embodiment, database 310 may include vehicle information, select service locations, claims inspection sites, and repair facility information, both historical and current. In the exemplary embodiment, database 310 may be stored remotely from RM computer device 220. In some embodiments, database 310 may be decentralized. In the exemplary embodiment, the user may access database 310 via user computer device 205 by logging onto RM computer device 220, as described herein.

RM computer device 220 may be communicatively coupled with one or more user computer devices 205. In some embodiments, RM computer device 220 may be associated with, or is part of a computer network associated with an insurance provider, or in communication with insurer network computer devices 210. In other embodiments, RM computer device 220 may be associated with a third party and is merely in communication with the insurer network computer devices 210. More specifically, RM computer device 220 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. RM computer device 220 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, RM computer device 220 hosts an application or website that allows the user to access the functionality described herein. In some further embodiments, user computer device 205 includes an application that facilitates communication with RM computer device 220.

In the exemplary embodiment, insurer network computer devices 210 include one or more computer devices associated with an insurance provider. In the exemplary embodiment, insurance provider is associated with the user and the user has an insurance policy that insures the object with insurance provider. In the exemplary embodiment, insurer network computer devices 210 include a web browser or a software application, which enables insurer network computer devices 210 to access remote computer devices, such as RM computer device 220 and database server 305, using the Internet or other network. More specifically, insurer network computer devices 210 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Insurer network computer devices 210 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, insurer network computer devices 210 may access database 310 to analyze repairs, vehicles, claims, and/or repair facility information.

In the exemplary embodiment, repair facility computer devices 215 include computer devices associated with repair facilities capable of repairing a vehicle or other object. In the exemplary embodiment, repair facility computer devices 215 include a web browser or a software application, which enables repair facility computer devices 215 to access remote computer devices, such as RM computer device 220, using the Internet or other network. More specifically, repair facility computer devices 215 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Repair facility computer devices 215 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, repair facility computer devices 215 may communicate with RM computer device 220 to schedule repair appointments. In some embodiments, repair facilities also function as inspection sites. In these embodiments, repair facility computer devices 215 may communicate with RM computer device 220 to provide information and/or storing information in the database 310. Repair facility computer devices 215 may communicate with database 310 to provide updates about a vehicle being repaired.

### Exemplary Client Device

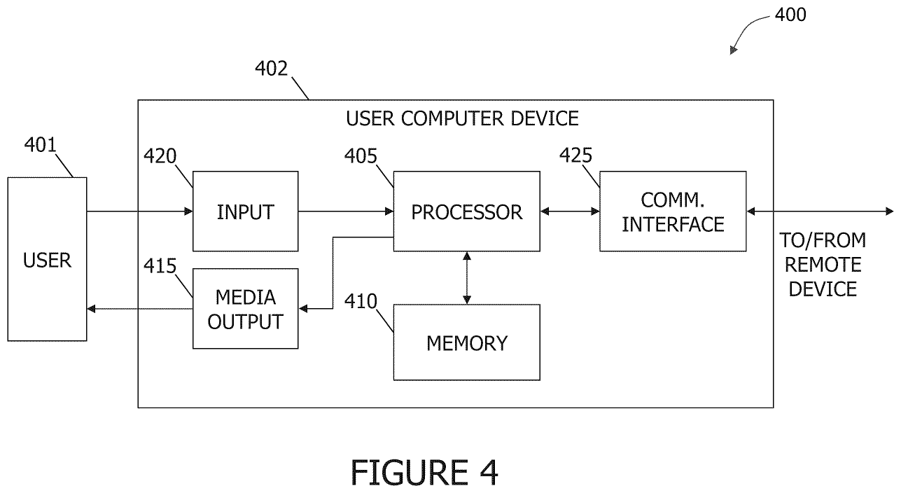

FIG. 4 depicts an exemplary configuration 400 of user computer device 402, in accordance with one embodiment of the present disclosure. In the exemplary embodiment, user computer device 402 may be similar to, or the same as, user computer device 205 (shown in FIG. 2). User computer device 402 may be operated by a user 401. User computer device 402 may include, but is not limited to, user computer devices 205, insurer network computer devices 210, and repair facility computer devices 215 (all shown in FIG. 2). User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or repair data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an interface for viewing repair facility locations. In some embodiments, user computer device 402 may include an input device 420 for receiving input from user 401. User 401 may use input device 420 to, without limitation, select a repair facility to view information about.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as RM computer device 220 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from RM computer device 22. A client application may allow user 401 to interact with, for example, RM computer device 220. For example, instructions may be stored by a cloud service, and the output of the execution of the instructions sent to the media output component 415.

### Exemplary Server Device

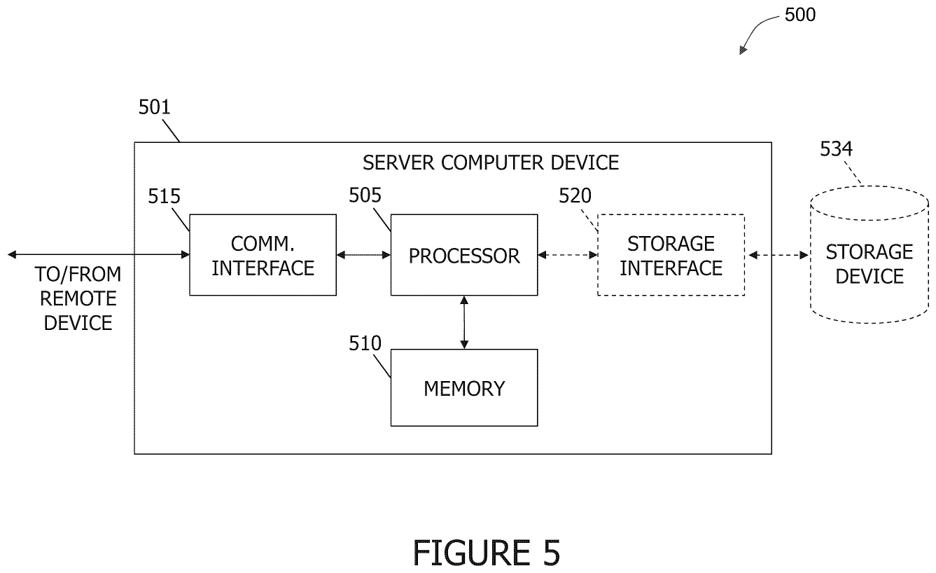

FIG. 5 depicts an exemplary configuration 500 of a server computer device 501, in accordance with one embodiment of the present disclosure. In the exemplary embodiment, server computer device 501 may be similar to, or the same as, RM computer device 220 (shown in FIG. 2). Server computer device 501 may include, but is not limited to, RM computer device 220, insurer network computer devices 210, repair facility computer device 215 (all shown in FIG. 2), and database server 305 (shown in FIG. 3). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, RM computer device 220, insurer network computer devices 210, repair facility computer device 215, and user computer devices 205 (shown in FIG. 2) (for example, using wireless communication or data transmission over one or more radio links or digital communication channels). For example, communication interface 515 may receive requests from user computer devices 205 via the Internet, as illustrated in FIG. 3.

Processor 505 may also be operatively coupled to a storage device 534. Storage device 534 may be any computer-operated hardware suitable for storing and/or retrieving data, such as, but not limited to, data associated with database 310 (shown in FIG. 3). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated in FIGS. 1 and 2.

### Exemplary Computer Device

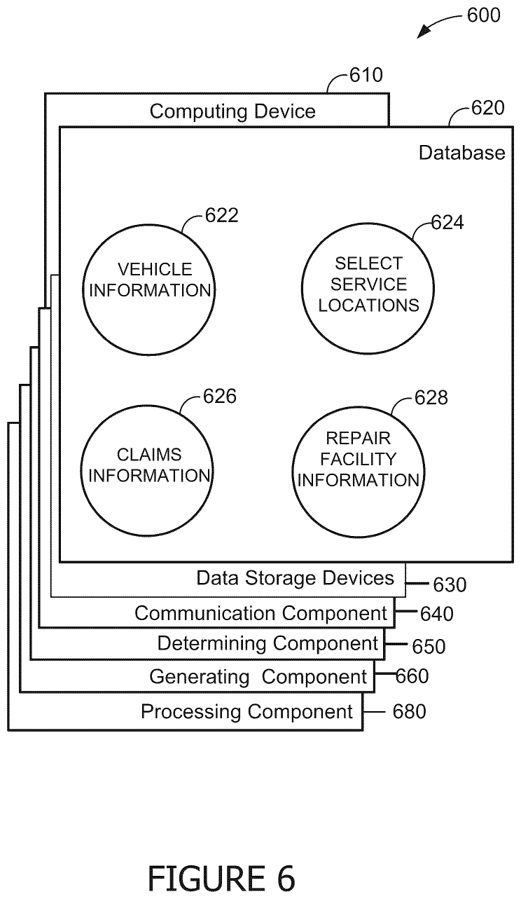

FIG. 6 depicts a diagram 600 of components of one or more exemplary computing devices 610 that may be used in system 300 shown in FIG. 3. In some embodiments, computing device 610 may be similar to RM computer device 220. Database 620 may be coupled with several separate components within computing device 610, which perform specific tasks. In this embodiment, database 620 may include vehicle information 622, select service locations 624, claims information 626, and repair facility information 628. In some embodiments, database 620 is similar to database 310 (shown in FIG. 3).

Computing device 610 may include the database 620, as well as data storage devices 630. Computing device 610 may also include a communication component 640 for collecting 110 a plurality of vehicle repair information from the plurality of repair facilities, receiving 120, from a user computer device 205, a query for information about one or more repair facilities, and instructing 130 the user computer device 205 to display the user interface (all shown in FIG. 1). Computing device 610 may further include a determining component 650 for analyzing 115 a current load for the corresponding repair facility for each of the plurality of repair facilities (shown in FIG. 1). Moreover, computing device 610 may include a generating component 660 for generating 125 a user interface to include results of the query based on the plurality of historical vehicle repair information and the plurality of vehicle repair information (shown in FIG. 1). A processing component 670 may assist with execution of computer-executable instructions associated with the system.

### Exemplary Computer-Implemented Method for Monitoring the Capacity of Repair Facilities

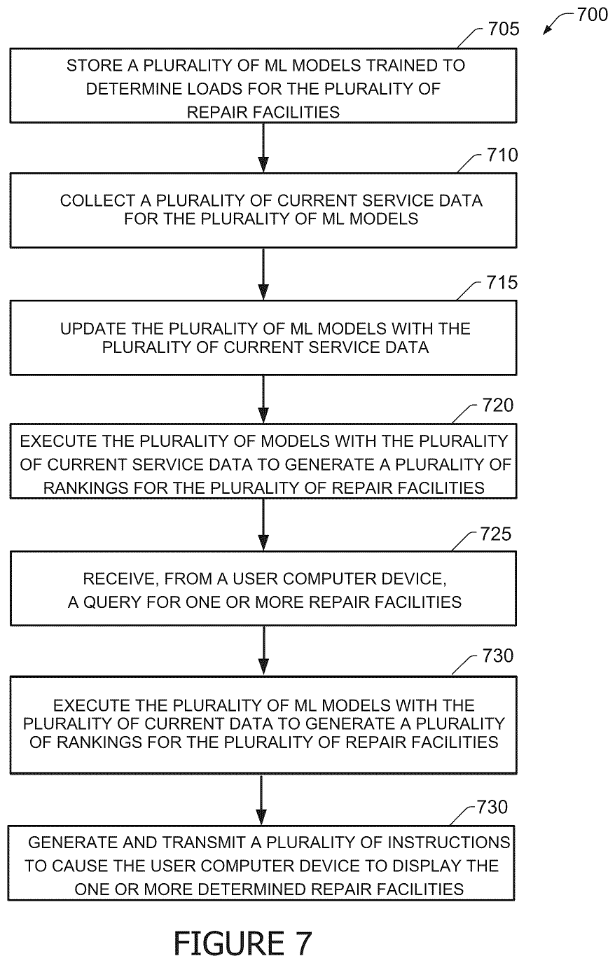

FIG. 7 illustrates a flow chart of another exemplary computer-implemented process 700 for one aspect of the process of monitoring the capacity of repair facilities, in accordance with the present disclosure. In the exemplary embodiment, process 700 is performed by a computer device associated with an insurance provider, such as repair monitoring (RM) computer device 220 (shown in FIG. 2). In other embodiments, process 700 is performed by a computer device in communication with an insurance provider. In the exemplary embodiment, RM computer device 220 is in communication with a user computer device, such as a mobile computer device, for example user computer device 205 (shown in FIG. 2). In this embodiment, RM computer device 220 performs process 700 by transmitting data to the user computer device 205 to be displayed to the user and receives the user's inputs from user computer device 205.

In the exemplary embodiment, the RM computer device 220 stores 705 a plurality of machine-learning models trained to determine loads for the plurality of repair facilities based upon a plurality of historical vehicle repair information for the plurality of repair facilities. In at least some embodiments, the plurality of historical vehicle repair information is stored in a database, such as database 310 (shown in FIG. 3).

In the exemplary embodiment, the RM computer device 220 collects 710 a plurality of current service data for the plurality of machine-learning models. In some embodiments, the RM computer device 220 trains the machine-learning models with a plurality of variables that may be provided by an insurance network computer device 210 and/or one or more user computer devices 205. These variables may include variables about the repair facility in question, the vehicle in question, any damage done to that vehicle, market attributes, insurance attributes, and/or any other attribute or variable desired.

In some embodiments, the repair facility variables may include, but are not limited to, repairer ID, total shop capacity, current shop capacity, market ID, repairer name, days to completion, Street, City, State, Zip Code, County, scores for the Repair Facility, ratings for the Repair Facility, one or more customer satisfaction indexes, and/or any other attribute or variable desired. The variables may also include RFL, which is a repair facility locator index, which is the placement in which the repair facilities based on a facility listing. The RFL is where the repair facility ranks in a market area as far as their performance goes. A further variable may be an RPM score, which is a Repair Performance Management score. It's a score between 0-1000. Repair facilities rank against each other in each market and the RFL is basically a copy of that number to help ranking in the repair facility locator.

The vehicle variables may include, but are not limited to, make, model, year, engine type, and/or any other attribute or variable desired. The damage done to the vehicle variables may consist of different codes to represent damage in different locations and/or the severity of the damage done to those locations. In some further embodiments, the damage done to the vehicle variables may also include an average amount of time to repair the corresponding damage to the vehicle, whether or not the vehicle is drivable, information about parts expected to be needed to repair the damage to the vehicle, and/or any other damage attributes or variables as needed. The market variables may include, but are not limited to, market ID, market name, current weather conditions, previous weather conditions, weather forecasts, previous average time to completion, number of repair facilities in the corresponding market, and/or any other attribute or variable desired.

In some embodiments, the one or more insurance variables may include, but are not limited to, policy coverage, preferred repair shops, rental vehicle coverage, ride share coverage, tow coverage, and/or any other attribute or variable as desired. In some embodiments, the one or more insurance variables are provided by an insurance network computer device. The one or more insurance variables from the insurance network computer device may be related to the vehicle and/or the incident in which the vehicle sustained the damage that is to be repaired, such as the vehicle variables and/or the damage variables.

In the exemplary embodiment, different markets affect the amount of repair facilities available. In some embodiments, different machine-learning models may be built for different markets aka locations to account for the variances in different parts of the country and to improve the training of the corresponding machine-learning models. For example, data from Kansas City may affect the model differently than data from Chicago. Accordingly, having machine-learning models tailored for the corresponding markets can allow for improved accuracy of prediction in those markets.

In some embodiments, the RM computer device 220 is in communication with a plurality of repair facility computer devices 215 (shown in FIG. 2), where each repair facility computer device 215 is associated with at repair facility of the plurality of repair facilities. In other embodiments, the plurality of repair facility computer devices 215 are in communication with the database 310 itself. In still other embodiments, the plurality of repair facility computer devices 215 are in communication with an insurer network computer device 210 and the insurer network computer device 210 receives the vehicle repair information and forwards the vehicle repair information to the database 310 and/or the RM computer device 220. In the exemplary embodiment, the RM computer device 220 stores the plurality of current service data from the plurality of repair facilities.

In the exemplary embodiment, the RM computer device 220 updates 715 the plurality of machine-learning models with the plurality of current service data. In some embodiments, the RM computer device 220 receives the plurality of current service data from a plurality of computer devices 215 associated with the plurality of repair facilities. In some further embodiments, the plurality of current service data includes a current load for each of the plurality of repair facilities. In additional embodiments, the plurality of current service data includes a plurality of vehicle repair information. In these embodiments, the RM computer device 220 analyzes the plurality of vehicle repair information. Then the RM computer device 220 executes one or more machine-learning models with the plurality of vehicle repair information as inputs to determine a current load for the corresponding repair facility. The RM computer device 220 adjusts the plurality of workload rankings for the plurality of repair facilities based upon the plurality of current loads. The RM computer device 220 reduces a workload ranking for a repair facility when the one or more machine-learning models determines that the repair facility is over capacity. In some of these embodiments, the RM computer device 220 determines that a repair facility is over capacity when an average time to completion is greater than or equal to 45 days.

In the exemplary embodiment, the RM computer device 220 executes 720 the plurality of machine-learning models with the plurality of current service data to generate a plurality of workload rankings for the plurality of repair facilities.

In the exemplary embodiment, the RM computer device 220 receives 725, from a user computer device 205, a query for one or more repair facilities.

In the exemplary embodiment, the RM computer device 220 executes 730 the query to determine the one or more repair facilities to respond based upon the plurality of workload rankings of the plurality of repair facilities.

In the exemplary embodiment, the RM computer device 220 generates and transmits 735, to the user computer device 205, a plurality of instructions to cause the user computer device 205 to display the one or more determined repair facilities. In some embodiments, the RM computer device 220 generates 125 a user interface to include results of the query based on the plurality of historical vehicle repair information and the plurality of vehicle repair information. In the exemplary embodiment, the RM computer device 220 generates the user interface and ranks the repair facilities for the user to select, where the user computer device 205 is instructed to display the user interface to the user on a display screen of the user computer device 205. In these embodiments, the RM computer device 220 adjusts the workload rankings based on whether or not the corresponding repair facility is over capacity or not.

In some embodiments, the RM computer device 220 remove a repair facility from the one or more determined repair facilities based upon a workload ranking of the repair facility.

In some further embodiments, the RM computer device 220 removes a repair facility from the one or more determined repair facilities based upon a current capacity of the repair facility.

In some additional embodiments, the RM computer device 220 receives a plurality of performance data from the plurality of repair facilities, such as via the repair facility computer devices 215. Then the RM computer device 220 retrains the plurality of machine-learning models based upon the plurality of performance data.

In still further embodiments, the RM computer device 220 collects a plurality of updated current service data for the plurality of machine-learning models. The RM computer device 220 updates the plurality of machine-learning models with the plurality of updated current service data. The RM computer device 220 executes the plurality of machine-learning models with the plurality of updated current service data to generate an updated plurality of workload rankings for the plurality of repair facilities.

In still additional embodiments, the RM computer device 220 determines a condition of a vehicle to be repaired. The RM computer device 220 re-ranks the plurality of repair facilities based upon the condition of the vehicle to be repaired.

In some embodiments, the RM computer device 220 ranks the plurality of repair facilities on a monthly basis. The RM computer device 220 also receives current service data from the plurality of repair facilities on a daily basis. The RM computer device 220 uses the current service data for a plurality of days (i.e., five) with one or more machine-learning models to determine the current capacity of the corresponding repair facility and then determines if the repair facility is at or over capacity. If the repair facility is over capacity, the RM computer device 220 may adjust the workload rankings. In some embodiments, if the repair facility is over capacity, the repair facility is not shown on the display. This display may be on a user computer device 205 and/or an insurer network computer device 210.

In some embodiments, the RM computer device 220 sorts the plurality of vehicle repair information by geographic area. The RM computer device 220 generates the user interface to provide vehicle repair information based on a user selected geographic area. For example, the geographic area may include, but is not limited to, enterprise, country, state, province, region, county, city, market, and/or individual repair facility.

In some further embodiments, the RM computer device 220 determines that a selected repair facility is over capacity. The RM computer device 220 instructs the user computer device 205 to present a notification warning that the repair facility may be over capacity.

In still additional embodiment, the RM computer device 220 generates a user interface to provide vehicle repair information based on a user selected geographic area.

In some embodiments, each model of the plurality of machine-learning models represents a different geographic regions. Each model includes a plurality of repair facilities in the corresponding geographic region. The RM computer device 220 ranks the plurality of repair facilities in the corresponding geographic regions.

In at least some embodiments, the RM computer device 220 determines a current capacity of the plurality of repair facilities based on the plurality of current service data information. In some further embodiments, the RM computer device 220 receives a current or future weather condition. Then the RM computer device 220 determines a needed capacity based on the current or future weather condition, the plurality of vehicle repair information, and the plurality of historical vehicle repair information.

While the above describe repairing vehicles, the object to be repaired may be, but is not limited to, a personal possession, such as an antique clock, a piece of artwork, and/or a piece of furniture.

### Exemplary Embodiments & Functionality

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) store a plurality of historical vehicle repair information for a plurality of repair facilities; (2) collect a plurality of vehicle repair information from the plurality of repair facilities; (3) for each of the plurality of repair facilities, analyze a current load for the corresponding repair facility; (4) receive, from a user computer device, a query for information about one or more repair facilities; (5) generate a user interface to include results of the query based on the plurality of historical vehicle repair information and the plurality of vehicle repair information; and/or (6) instruct the user computer device to display the user interface. The computer system may have additional, less, or alternate functionality, including that discussed elsewhere herein.

An enhancement of the system may include a processor configured for monitoring repair facilities. The information may be, for instance, retrieved from one or more memory units and/or acquired via one or more sensors, including microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

In a further enhancement, the computer system may analyze the plurality of vehicle repair information. The computer system may further execute one or more machine-learning models with the plurality of vehicle repair information as inputs to determine the current load for the corresponding repair facility. The computer system may also determine a plurality of workload rankings for the plurality of repair facilities. In addition, the computer system may adjust the plurality of workload rankings for the plurality of repair facilities based upon the plurality of current loads. Moreover, the computer system may reduce a workload ranking for a repair facility when the one or more machine-learning models determines that the repair facility is over capacity. Additionally, the computer system may determine that a repair facility is over capacity when an average time to completion is greater than or equal to 45 days.

In yet a further enhancement, the computer system may sort the plurality of vehicle repair information by geographic area. The computer system may further generate the user interface to provide vehicle repair information based on a user selected geographic area.

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) collect a plurality of current service data for a plurality of machine-learning models trained to determine workloads for the plurality of vehicle repair facilities based upon a plurality of historical service data for the plurality of repair facilities; (2) execute the plurality of machine-learning models with input of the plurality of current service data to generate a workload ranking for the plurality of repair facilities; (3) receive, from a user computer device, a query requesting service for repairing a user vehicle provided by one or more of the repair facilities; (4) execute the query to determine the one or more repair facilities having availability based upon the plurality of workload rankings of the plurality of repair facilities to provide the service for repairing the user vehicle; and/or (5) cause the user computer device to display a the one or more determined repair facilities. The computer system may have additional, less, or alternate functionality, including that discussed elsewhere herein.

An enhancement of the system may include a processor configured for monitoring repair facilities. The information may be, for instance, retrieved from one or more memory units and/or acquired via one or more sensors, including microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

In a further enhancement, the computer system may receive the plurality of current service data from a plurality of computer devices associated with the plurality of repair facilities.

In a further enhancement, the plurality of current service data may include a current load for each of the plurality of repair facilities.

In a further enhancement, the computer system may remove a repair facility from the one or more determined repair facilities based upon a workload ranking of the repair facility.

In a further enhancement, the computer system may remove a repair facility from the one or more determined repair facilities based upon a current capacity of the repair facility.

In a further enhancement, the computer system may receive a plurality of performance data from the plurality of repair facilities. The computer system may also retrain the plurality of machine-learning models based upon the plurality of performance data.

In a further enhancement, the computer system may collect a plurality of updated current service data for the plurality of machine-learning models. The computer system may also update the plurality of machine-learning models with the plurality of updated current service data. The computer system may further execute the plurality of machine-learning models with the plurality of updated current service data to generate an updated plurality of workload rankings for the plurality of repair facilities.

In a further enhancement, the computer system may determine a condition of a vehicle to be repaired. The computer system may further re-rank the plurality of repair facilities based upon the condition of the vehicle to be repaired.

In a further enhancement, the plurality of current service data includes a plurality of vehicle repair information. The computer system may analyze the plurality of vehicle repair information. The computer system may further execute one or more machine-learning models with the plurality of vehicle repair information as inputs to determine a current load for the corresponding repair facility. The computer system may also adjust the plurality of workload rankings for the plurality of repair facilities based upon the plurality of current loads. The computer system may additionally reduce a workload ranking for a repair facility when the one or more machine-learning models determines that the repair facility is over capacity. Moreover, the computer system may determine that a repair facility is over capacity when an average time to completion is greater than or equal to 45 days.

In a further enhancement, the computer system may generate a user interface to provide vehicle repair information based on a user selected geographic area.

In a further enhancement, each model of the plurality of machine-learning models may represent a different geographic regions. Each model may include a plurality of repair facilities in the corresponding geographic region. The computer system may rank the plurality of repair facilities in the corresponding geographic regions.

In yet another aspect, a computer-implemented method of monitoring a plurality of repair facilities may be provided. The computer-implemented method may be performed by a computing device including at least one processor and/or associated transceiver. The method may include, via the at least one processor and/or associated transceiver: (1) collecting a plurality of current service data for a plurality of machine-learning models trained to determine workloads for the plurality of vehicle repair facilities based upon a plurality of historical service data for the plurality of repair facilities; (2) executing the plurality of machine-learning models with input of the plurality of current service data to generate a workload ranking for the plurality of repair facilities; (3) receiving, from a user computer device, a query requesting service for repairing a user vehicle provided by one or more of the repair facilities; (4) executing the query to determine the one or more repair facilities having availability based upon the plurality of workload rankings of the plurality of repair facilities to provide the service for repairing the user vehicle; and/or (5) causing the user computer device to display a the one or more determined repair facilities. The method may have additional, less, or alternate functionality, including that discussed elsewhere herein.

An enhancement of the method may include monitoring repair facilities. The interactions may be, for instance, retrieved from one or more memory units and/or acquired via one or more sensors, including cameras, microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the method may include receiving the plurality of current service data from a plurality of computer devices associated with the plurality of repair facilities.

A further enhancement of the method may include where the plurality of current service data includes a current load for each of the plurality of repair facilities.

A further enhancement of the method may include removing a repair facility from the one or more determined repair facilities based upon a workload ranking of the repair facility.

A further enhancement of the method may include removing a repair facility from the one or more determined repair facilities based upon a current capacity of the repair facility.

A further enhancement of the method may include receiving a plurality of performance data from the plurality of repair facilities. The method may also include retraining the plurality of machine-learning models based upon the plurality of performance data.

A further enhancement of the method may include collecting a plurality of updated current service data for the plurality of machine-learning models. The method may also include updating the plurality of machine-learning models with the plurality of updated current service data. The method may further include executing the plurality of machine-learning models with the plurality of updated current service data to generate an updated plurality of workload rankings for the plurality of repair facilities.

A further enhancement of the method may include determining a condition of a vehicle to be repaired. The method may also include re-ranking the plurality of repair facilities based upon the condition of the vehicle to be repaired.

A further enhancement of the method may include where the plurality of current service data includes a plurality of vehicle repair information. The method may also include analyzing the plurality of vehicle repair information. The method may further include executing one or more machine-learning models with the plurality of vehicle repair information as inputs to determine a current load for the corresponding repair facility.

A further enhancement of the method may include adjusting the plurality of workload rankings for the plurality of repair facilities based upon the plurality of current loads. The method may also include reducing a workload ranking for a repair facility when the one or more machine-learning models determines that the repair facility is over capacity. The method may further include determining that a repair facility is over capacity when an average time to completion is greater than or equal to 45 days. Additionally, the method may include generating a user interface to provide vehicle repair information based on a user selected geographic area.

A further enhancement of the method may include where each model of the plurality of machine-learning models represents a different geographic regions. The method may also include where each model includes a plurality of repair facilities in the corresponding geographic region. The method may further include comprising ranking the plurality of repair facilities in the corresponding geographic regions.

In still another aspect, a non-transitory computer readable medium having computer-executable instructions embodied thereon for evaluating aspects of health of a residential property may be provided. When executed by at least one processor and/or associated transceiver, the computer-executable instructions cause the at least one processor and/or associated transceiver to: (1) collect a plurality of current service data for a plurality of machine-learning models trained to determine workloads for the plurality of vehicle repair facilities based upon a plurality of historical service data for the plurality of repair facilities; (2) execute the plurality of machine-learning models with input of the plurality of current service data to generate a workload ranking for the plurality of repair facilities; (3) receive, from a user computer device, a query requesting service for repairing a user vehicle provided by one or more of the repair facilities; (4) execute the query to determine the one or more repair facilities having availability based upon the plurality of workload rankings of the plurality of repair facilities to provide the service for repairing the user vehicle; and/or (5) cause the user computer device to display a the one or more determined repair facilities. The computer readable medium may have instructions that direct additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Machine-learning models may be created based upon example inputs in order to make valid and reliable predictions for novel inputs.

Additionally or alternatively, the machine learning programs may be trained by inputting sample (e.g., training) data sets or certain data into the programs, such as image data of objects to be analyzed (e.g., vehicle damage), mobile device data, and/or vehicle telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining, or associate rule mining techniques, and/or the use of neural networks. In some embodiments, semi-supervised learning techniques may be employed. In one embodiment, machine learning techniques may be used to extract data about the object, vehicle, user, damage, needed repairs, costs and/or incident from vehicle data, insurance policies, geolocation data, image data, and/or other data.

In the exemplary embodiment, a processing element may be trained by providing it with a large sample of repair and vehicle damage data with known characteristics or features. Such information may include, for example, information associated with a shape, size, and/or type of damage as well as the qualifications of various repair facilities and past choices of users related to different repair facilities based on information such as insurance policies, geolocation data, image data, and/or other data.

Based upon these analyses, the processing element may learn how to identify characteristics and patterns that may then be applied to analyzing repair data. For example, the processing element may learn, with the user's permission or affirmative consent, to identify the repair facilities most appropriate for certain types of vehicles and certain types of damages. The processing element may also learn how to identify attributes of different repair facilities to determine whether or not to keep or drop a specific repair facility and whether to add repair facilities based on weather conditions.

### Technical Advantages

The aspects described herein may be implemented as part of one or more computer components such as a client device and/or one or more back-end components, such as a repair assessment engine, for example. Furthermore, the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

For instance, aspects include analyzing various sources of data to determine up to date, real-time capacity, and capabilities of repair facilities to correctly direct users in need of repairs. In doing so, the aspects overcome issues associated with the inconvenience of manually contacting repair facilities to determine their current capacity and whether or not they can repair additional vehicles, as well as the issue of driving all business to one or two repair facilities and overwhelming them so that repairs take a long time. Without the improvements suggested herein, additional processing and memory usage would be required to perform such coordination. Additional technical advantages include, but are not limited to: i) improved speed and responsiveness in repairing an object; ii) preventing the repair process from being hung up by a dropped step; iii) monitoring the repair process across multiple repair facilities; iv) allowing for real-time analysis of the current availability of repair facilities and their capabilities; v) allow for program management to ensure customers are provided availability for estimate and repairs; vi) allow for program admin to enforce vehicle prioritization agreements to give priority over other vehicles during the repair process; and vii) allowing for data driven decisions around repair facility capacity, such as, but not limited to, adding capacity, removing capacity, and assisting with weather, etc.

Furthermore, another advantage of the described system and method is that by performing batch processing, the system and method reduce the amount of computer resources used and needed. This is a technical advantage to improve the underlying technologies.

Furthermore, the embodiments described herein improve upon existing technologies, and improve the functionality of computers, by more accurately predicting or identifying which repair facilities have capacity. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to efficiency metrics and ease of use, for example.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system for real-time monitoring of a workload for a plurality of repair facilities, the computer system comprising at least one processor in communication with at least one memory device, the computer system in communication with a user computer device associated with a user, the at least one processor is programmed to:
collect a plurality of current service data for a plurality of machine-learning models trained to determine workloads for the plurality of vehicle repair facilities based upon a plurality of historical service data for the plurality of repair facilities;
execute the plurality of machine-learning models with input of the plurality of current service data to generate a workload ranking for the plurality of repair facilities;
receive, from a user computer device, a query requesting service for repairing a user vehicle provided by one or more of the repair facilities;
execute the query to determine the one or more repair facilities having availability based upon the plurality of workload rankings of the plurality of repair facilities to provide the service for repairing the user vehicle; and
cause the user computer device to display a the one or more determined repair facilities.

2. The computer system of claim 1, wherein the at least one processor is further programmed to receive the plurality of current service data from a plurality of computer devices associated with the plurality of repair facilities.

3. The computer system of claim 1, wherein the plurality of current service data includes a current workload of repairing a plurality of vehicles at each of the plurality of repair facilities including a number of vehicles requiring repair at each repair facility and types of repairs or services being provided for each vehicle.

4. The computer system of claim 1, wherein the at least one processor is further programmed to automatically remove a repair facility from a list of the one or more determined repair facilities based upon the workload ranking of the repair facility.

5. The computer system of claim 1, wherein the at least one processor is further programmed to remove a repair facility from the one or more determined repair facilities based upon a current capacity of the repair facility.

6. The computer system of claim 1, wherein the at least one processor is further programmed to:
receive a plurality of performance data from the plurality of repair facilities; and
retrain the plurality of machine-learning models based upon the plurality of performance data.

7. The computer system of claim 1, wherein the at least one processor is further programmed to:
collect a plurality of updated current service data for the plurality of machine-learning models;
update the plurality of machine-learning models with the plurality of updated current service data; and
execute the plurality of machine-learning models with the plurality of updated current service data to generate an updated plurality of workload rankings for the plurality of repair facilities.

8. The computer system of claim 1, wherein the at least one processor is further programmed to:
determine a condition of a vehicle to be repaired; and
re-rank the plurality of repair facilities based upon the condition of the vehicle to be repaired.

9. The computer system of claim 1, wherein the plurality of current service data includes a plurality of vehicle repair information, and wherein the at least one processor is further programmed to:
analyze the plurality of vehicle repair information; and
execute one or more machine-learning models with the plurality of vehicle repair information as inputs to determine a current load for the corresponding repair facility.

10. The computer system of claim 9, wherein the at least one processor is further programmed to adjust the plurality of workload rankings for the plurality of repair facilities based upon the plurality of current loads.

11. The computer system of claim 10, wherein the at least one processor is further programmed to reduce a workload ranking for a repair facility when the one or more machine-learning models determines that the repair facility is over capacity.

12. The computer system of claim 9, wherein the at least one processor is further programmed to determine that a repair facility is over capacity when an average time to completion is greater than or equal to 45 days.

13. The computer system of claim 1, wherein the at least one processor is further programmed to update the plurality of machine-learning models with the plurality of current service data.

14. The computer system of claim 1, wherein the at least one processor is further programmed to generate a user interface to provide vehicle repair information based on a user selected geographic area.

15. The computer system of claim 1, wherein each model of the plurality of machine-learning models represents a different geographic regions.

16. The computer system of claim 15, wherein each model includes a plurality of repair facilities in the corresponding geographic region.

17. The computer system of claim 16, wherein the at least one processor is further programmed to rank the plurality of repair facilities in the corresponding geographic regions.

18. A computer-implemented method for monitoring a plurality of repair facilities, the computer-implemented method performed by one or more processors in communication with a memory, the computer-implemented method comprising:
collecting a plurality of current service data for a plurality of machine-learning models trained to determine workloads for the plurality of vehicle repair facilities based upon a plurality of historical service data for the plurality of repair facilities;
executing the plurality of machine-learning models with input of the plurality of current service data to generate a workload ranking for the plurality of repair facilities;
receiving, from a user computer device, a query requesting service for repairing a user vehicle provided by one or more of the repair facilities;
executing the query to determine the one or more repair facilities having availability based upon the plurality of workload rankings of the plurality of repair facilities to provide the service for repairing the user vehicle; and
causing the user computer device to display a the one or more determined repair facilities.

19. The computer-implemented method of claim 18 further comprising receiving the plurality of current service data from a plurality of computer devices associated with the plurality of repair facilities.

20. At least one non-transitory computer-readable storage media having computer-executable instructions embodied thereon, wherein when executed by a computer system for detecting and acting upon operator reliance to vehicle alerts, the computer system including one or more processors and a memory, the computer-executable instructions cause the one or more processors to:
collect a plurality of current service data for a plurality of machine-learning models trained to determine workloads for the plurality of vehicle repair facilities based upon a plurality of historical service data for the plurality of repair facilities;
execute the plurality of machine-learning models with input of the plurality of current service data to generate a workload ranking for the plurality of repair facilities;
receive, from a user computer device, a query requesting service for repairing a user vehicle provided by one or more of the repair facilities;
execute the query to determine the one or more repair facilities having availability based upon the plurality of workload rankings of the plurality of repair facilities to provide the service for repairing the user vehicle; and
cause the user computer device to display a the one or more determined repair facilities.
